(19) United States
(12) Patent Application Publication
(10) Pub. No.: US 2012/0317544 A1
(43) Pub. Date: Dec. 13, 2012

(54) INFORMATION PROCESSING APPARATUS AND INFORMATION PROCESSING METHOD

(76) Inventors: Yoriko KOMATSUZAKI, Tokyo (JP); Hiroki Nagahama, Tokyo (JP); Kazumi Sato, Kanagawa (JP); Kazuhito Narita, Tokyo (JP)

(21) Appl. No.: 13/490,120

(22) Filed: Jun. 6, 2012

(30) Foreign Application Priority Data
Jun. 13, 2011 (JP) 2011-131297

(51) Int. Cl. G06F 9/44

(52) U.S. Cl. 717/106; 717/121

(57) ABSTRACT

There is provided an information processing apparatus including a comparison unit for comparing intermediate code converted from a source code of the program being developed with an intermediate code of the program stored in a database in the system development. The information processing apparatus also includes a similarity calculation unit for calculating a similarity between the programs based on a comparison result obtained by the comparison unit. A narrowing-down process is performed for a candidate to be recommended using additional information as occasion demands. The present disclosure can apply to the information processing method.

### BACKGROUND

The present disclosure relates to an information processing apparatus and method and, more particularly, to an information processing apparatus and method capable of recommending a source code from which more preferable processing details or execution results are obtainable.

In recent years, when a user edits a program, makes a configuration for software development, or creates a document, if the user wants to get desired information from the books, Internet, and the like, then the user can search and obtain the desired information using a table of books or a search engine. This searching task generally becomes more cumbersome particularly when the scale or complexity of a target to be searched becomes increased. The user often refers to the previous examples. In this case, it has been necessary for a user to classify and select the contents described in books or the Internet search results and to determine whether the selected things are suitable for the desired information.

Furthermore, since the Internet searching is done particularly based on keywords entered by a user, some information obtained from search results often may be unnecessary or inappropriate for the user. Thus, it has been necessary for the user to check the information carefully once more and to handle laborious works, and also it has been easy to mistake.

As an example of information searching method, there has been proposed a method for recommending an existing source code which is similar to a source code of a program to be generated to a user (for example, “A-SCORE: Software Component Recommendation System Based on Source Code under Development” by Ryuji Shimada, Makoto Ichii, Yasuhiro Hayase, Makoto Matsushita, and Katsuro Inoue, by Information Processing Society of Japan, Vol. 50, 3095-3107, December 2009 (hereinafter referred to simply as Non-Patent Literature 1)). According to the method disclosed in Non-Patent Literature 1, the source code to be recommended is determined by comparing the source codes with each other.

### SUMMARY

However, even though the source codes are similar to each other in their descriptions, their executable files may be not similar to each other. The important thing in software development is processing details (processing procedures) or execution results rather than the description of a source code. For this reason, the method disclosed in Non-Patent Literature 1 has a problem that an inappropriate source code may be recommended to a user.

It is desirable to provide a technique capable of recommending a source code from which more preferable processing details or execution results are obtainable.

According to an embodiment of the present disclosure, there is provided an information processing apparatus which includes a comparison unit for comparing intermediate codes of programs with each other, and a similarity calculation unit for calculating a similarity between the programs based on a comparison result obtained by the comparison unit.

The information processing apparatus may further include a determination unit for determining a program to be recommended based on the similarity calculated by the similarity calculation unit, and a recommendation unit for recommending the program determined by the determination unit.

The information processing apparatus may further include a candidate selection unit for selecting a candidate of the program to be recommended based on the similarity calculated by the similarity calculation unit, and a narrowing-down unit for narrowing down the candidates selected by the candidate selection unit based on additional information of the program. The determination unit may determine the candidate narrowed down by the narrowing-down unit as the program to be recommended.

The information processing apparatus may further include a weight setting unit for setting a weight of the program determined by the determination unit in accordance with the additional information of the program, and a priority determination unit for determining a priority of the program determined by the determination unit by using a weight set by the weight setting unit, the weight corresponding to each of the additional information.

The information processing apparatus may further include a weight updating unit for updating the weight set by the weight setting unit, the weight corresponding to each of the additional information, in accordance with a user instruction.

The additional information may include a source code language type of the program.

The additional information may include an editing date and time of a source code of the program.

The additional information may include information representing a library which contains a source code of the program.

The additional information may include a license of a source code of the program.

The additional information may include an intermediate code type of the program.

The additional information may include an option for generating an intermediate code of the program.

The additional information may include an execution result of a source code of the program.

The additional information may include a past record of use of a source code of the program.

The additional information may include a degree of change in a source code of the program.

The additional information may include information relevant to an updating of the program.

The information processing apparatus may further include a code conversion unit for converting a source code of the program into an intermediate code. The comparison unit performs a comparison between the intermediate codes converted from the source code of the program by the code conversion unit.

The information processing apparatus may further include a receiving unit for receiving a user instruction, and a source code generation unit for generating a source code of the program based on the user instruction received by the receiving unit. The code conversion unit may perform a conversion of the source code generated by the source code generation unit into the intermediate code.

According to another embodiment of the present disclosure, there is provided an information processing method of an information processing apparatus. The method include comparing, at a comparison unit, intermediate codes of programs with each other, and calculating, at a similarity calculation unit, a similarity between the programs based on a comparison result obtained by the comparison unit.

According to the embodiments of the present disclosure, intermediate codes of programs may be compared with each other, and a similarity between the programs may be calculated based on a comparison result obtained by the comparison unit.

According to the embodiments of the present disclosure described above, it is possible to process information, and more particularly, to recommend a source code from which more preferable processing details or execution results are obtainable.

### BRIEF DESCRIPTION OF THE DRAWINGS

FIG. 1 is a block diagram illustrating a main configuration example of a development support system according to an embodiment of the present disclosure;

FIG. 2 is a block diagram illustrating a main configuration example of a terminal device according to an embodiment of the present disclosure;

FIG. 3 is a block diagram illustrating a main configuration example of a data server according to an embodiment of the present disclosure;

FIG. 4 is a diagram illustrating an example of an arrangement which realizes an integrated development environment and a recommendation engine by executing a program according to an embodiment of the present disclosure;

FIG. 5 is a flowchart illustrating a procedure example of a dataset recommendation process according to an embodiment of the present disclosure;

FIG. 6 is a flowchart illustrating a procedure example of a candidate narrowing-down process according to an embodiment of the present disclosure;

FIG. 7 is a flowchart illustrating a procedure example of a priority setting process according to an embodiment of the present disclosure; and

FIG. 8 is a flowchart illustrating a procedure example of a recommendation condition designation updating process according to an embodiment of the present disclosure.

### DETAILED DESCRIPTION OF THE EMBODIMENTS

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

An embodiment for implementing the present disclosure (hereinafter simply referred to as “embodiment”) will be described below. In addition, the description will be made in the following order.

### 1. First Embodiment

### Development Support System

### 1. First Embodiment

[Development Support System]

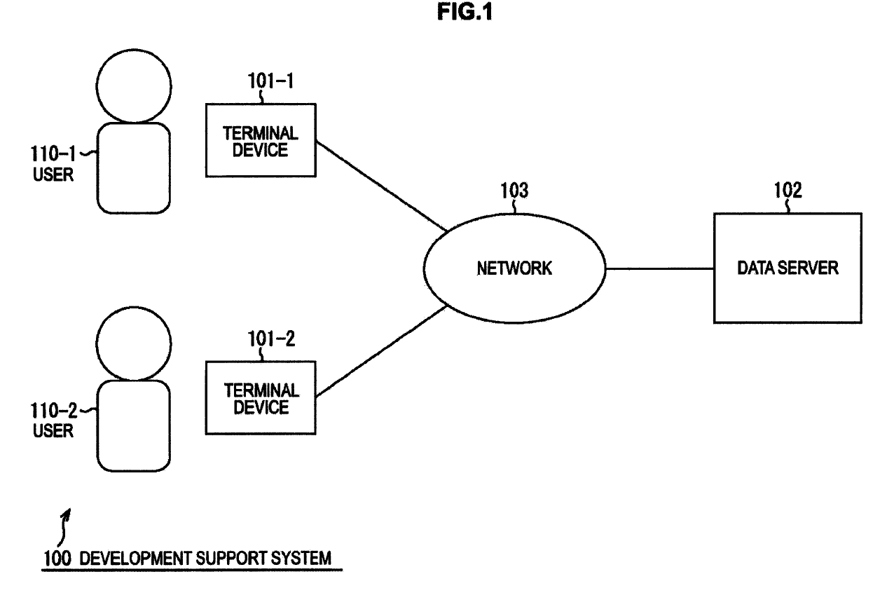

FIG. 1 is a block diagram illustrating a main configuration example of a development support system. The development support system 100 shown in FIG. 1 is a system for supporting the development of a system such as software and hardware. As shown in FIG. 1, the development support system 100 includes a terminal device 101-1, a terminal device 101-2, and a data server 102, which are connected to be communicable with each other through a network 103.

The terminal device 101-1 provides a user 110-1 who may be an engineer developing a system with a user interface such as a character-based user interface (CUI) or a graphical user interface (GUI). The terminal device 101-2 provides a user 110-2 who may be an engineer developing a system with the user interface such as the CUI or GUI. In the following description, the terminal device 101-1 and the terminal device 101-2 may be collectively referred to as a terminal device 101 except when there is a need to distinguish between them for explanation. In a similar manner, the user 110-1 and the user 110-2 may be collectively referred to as a user 110 except when there is a need to distinguish between them for explanation.

In FIG. 1, while the development support system 100 including two terminal devices 101 is shown, the number of the terminal device 101 is optional and may be one or may be three or more. In a similar manner, the number of the user 110 is optional and may be one or may be three or more.

The terminal device 101 provides the user 110 with an image such as the CUI or GUI by displaying the image on a monitor, outputs an audio from a speaker, or even receives instructions from the user 110 using an input device such as a keyboard.

The terminal device 101 also communicates with the data server 102 through the network 103 based on the received user instructions and the like. Further, the terminal device 101 transmits and receives information to and from the data server 102 through the network 103 based on the received user instruction.

The data server 102 has a database for storing a dataset containing a source code, which is supplied from, for example, the terminal device 101. The data server 102 selects a recommendation dataset which is to be recommended to a user of a group of datasets managed in the database and provides the terminal device 101 with the recommendation dataset through the network 103, for example, according to instructions from the terminal device 101.

In FIG. 1, while the development support system 100 including one data server 102 is shown, the number of the data server 102 is optional and may be two or more.

The network 103 may be a communication line such as a local area network (LAN), the Internet, and the like. The communication can be performed between the data server 102 and each of the terminal devices 101 through the network 103. The network 103 may be a wired, wireless or combination of wired and wireless communication network. The configuration of the network 103 may be optional and may be configured to include only one communication network or any combination of a plurality of communication networks.

In system development using this development support system 100, the user 110 operates the terminal device 101 and generates a source code of a program to write the program. A dataset including the source code is provided to the data server 102 through the network 103 and is stored and managed in a database. The data server 102 selects a dataset which is to be recommended and relevant (e.g., similar) to the dataset provided by the terminal device 101 of a group of datasets managed in the database. The data server 102 then provides the terminal device 101 with the selected dataset as a recommendation dataset. The terminal device 101 presents the recommendation dataset to the user. The user can develop a system by appropriately using the presented recommendation dataset.

[Terminal Device]

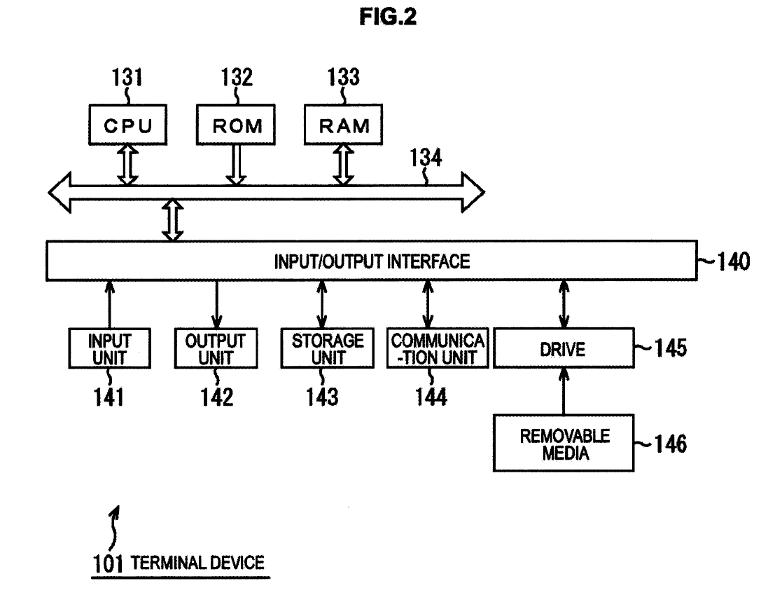

FIG. 2 is a block diagram illustrating a main configuration example of the terminal device 101. As shown in FIG. 2, the terminal device 101 includes a central processing unit (CPU) 131, a read-only memory (ROM) 132, a random access memory (RAM) 133, and a bus 134. The CPU 131 executes a variety of processes according to a program stored in the ROM 132 or loaded from a storage unit 143 into the RAM 133. Some data necessary for the CPU 131 to execute a variety of processes is appropriately stored in the RAM 133. The CPU 131, the ROM 132, and the RAM 133 are connected with each other via the bus 134.

As shown in FIG. 2, the bus 134 is also connected with an input/output interface 140. In addition, the terminal device 101 further includes an input unit 141, an output unit 142, the storage unit 143, and a communication unit 144, which are connected with the input/output interface 140.

The input unit 141 may configured to include any input device such as a keyboard, a mouse, a touch panel, a camera, or a microphone. The input unit 141 is operable by the user 110 and receives instructions provided from the user 110. The input unit 141 also provides the received instructions to an appropriate destination such as the CPU 131 or the RAM 133 through the input/output interface 140. In addition, the number and type of the input device which constitutes the input unit 141 are optional. That is, there are no limits to what kind of input devices can be used, how many input devices are used, and how to combine input devices.

The output unit 142 may be configured to include any output device such as a display, for example, a cathode ray tube (CRT) display, a liquid crystal display (LCD) or an organic electroluminescence display (OLED), a projector, or a speaker. The output unit 142 obtains output information provided, for example, from the CPU 131 and the RAM 133 through the input/output interface 140 and presents the output information to the user 110 by outputting the output information to the outside of the terminal device 101 in the form of at least one of video and audio formats. The number and type of the output device which constitutes the output unit 142 are optional. That is, there are no limits to what kind of output devices can be used, how many output devices are used, and how to combine output devices.

The storage unit 143 may be configured to include any storage medium such as a RAM disk, a flash memory, a solid state drive (SSD), or a hard disk. The storage unit 143 obtains and stores information provided, for example, from the CPU 131 through the input/output interface 140. The storage unit 143 also supplies an appropriate destination such as the CPU 131 and RAM 133 with the stored information at a predetermined timing or based on the instructions provided, for example, from the exterior such as the CPU 131. The number and type of the storage medium which constitutes the storage unit 133 are optional. That is, there are no limits to what kind of storage media can be used, how many storage media are used, and how to combine storage media.

The communication unit 144 is configured to include any communication device such as a communication interface having any communication specification, for example, of a wired LAN, wireless LAN, Bluetooth, universal serial bus (USB), institute of electrical and electronic engineer (IEEE) 1394 or high-definition multimedia interface (HDMI), a modem, a terminal adapter (TA), a 3G (third generation) wireless communication module, an infrared communication module, an non-contact type integrated circuit (IC) card, an external input terminal, an external output terminal, and the like. The communication unit 144 may obtain output information supplied, for example, from the CPU 131 or the RAM 133 through the input/output interface 140 and transmit the output information to the other device. The communication unit 144 also may obtain input information transmitted from the other devices and supply an appropriate destination such as the CPU 131 or the RAM 133 with the input information through the input/output interface 140. The number and type of the communication device which constitutes the communication unit 144 are optional. That is, there are no limits to what kind of communication devices can be used, how many communication devices are used, and how to combine communication devices.

The input/output interface 140 is also connected with a drive 145 as necessary. The drive 145 is appropriately equipped with any removable media 146 such as a magnetic disk, an optical disc, a magneto-optical disk, or a semiconductor memory, from which a computer program is read. The read computer program is installed on the storage unit 143 and the like as necessary. In addition, the drive 145 may write information to rewritable, removable media 146. In this case, the drive 145 writes and registers the information supplied from the CPU 131 or the RAM 133 through the input/output interface 140 to the removable media 146 with which the drive 145 is equipped.

[Data Server]

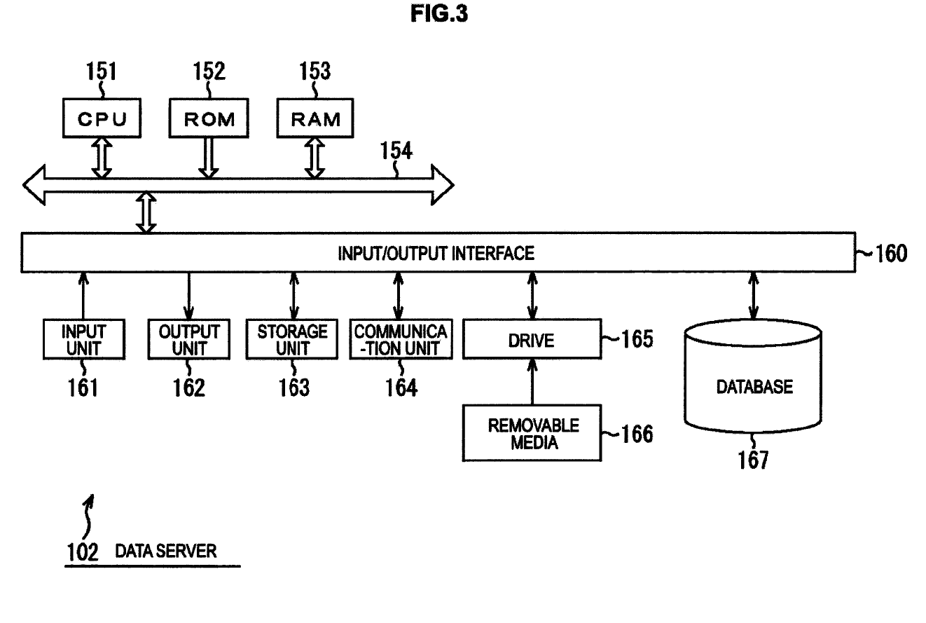

FIG. 3 is a block diagram illustrating a main configuration example of the data server 102. As shown in FIG. 3, the data server 102 has a similar configuration to the terminal device 101. The data server 102 includes a CPU 151, a ROM 152, a RAM 153, a bus 154, an input/output interface 160, an input unit 161, an output unit 162, a storage unit 163, and a communication unit 164. The input/output interface 160 may be optionally connected with a drive 165 which is appropriately equipped with a removable media 166.

Each unit described above has similar structures and functions as those of the terminal device 101 described with reference to FIG. 2, thus a detailed description thereof will be omitted herein.

The data server 102 may further include a database 167. The database 167 may include any storage media such as a RAM disk, a flash memory, a SSD, or a hard disk. The database 167 obtains information provided, for example, from the CPU 151 or the RAM 153 through the input/output interface 160. The database 167 also stores the information into the storage media and manages the stored information. The database 167 provides the information managed therein to appropriate destination such as the CPU 151 or the RAM 153, as necessary. The database 167 may store and manage the data and configuration settings relevant to system development, such as a dataset including a source code written by the user 110.

[Development Support Service]

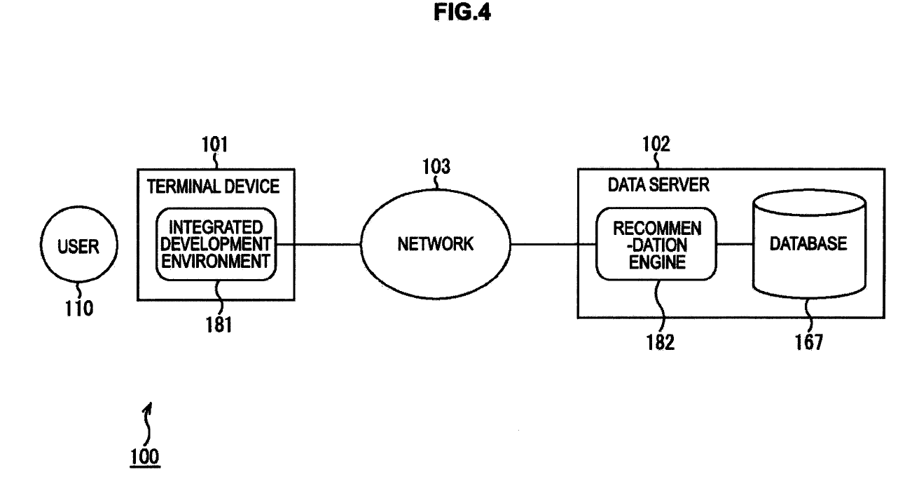

An overview of a development support service that the development support system 100 shown in FIG. 1 provides to the user 110 will be given with reference to FIGS. 1 to 4.

The CPU 131 executes a predetermined program (with the exception of programs being developing) which is stored in the storage unit 143 and the like, thereby implementing an integrated development environment 181. The integrated development environment 181 provides the user 110 with the CUI or GUI relevant to the system development. The user 110 develops a program according to the user interface. For example, the user 110 performs a variety of operations such as the generation, editing and deletion of the source code or configuration data of the program. In addition, the user 110 can issue any control instructions such as saving or reading of data according to the user interface.

A source code can be generated with any programming language which can be used in the integrated development environment 181, such as C, C++, Java (registered trademark), Fortran, Pascal, Lisp, ML, Haskell, Ruby, and the like.

The configuration data is a data group which can be selected and entered by a user in the integrated development environment 181, such as a field or menu selectable from the integrated development environment 181, or a field which can be inputted by the user.

The integrated development environment 181 gathers the generated source code or configuration data, and generates a dataset for a program. The dataset includes, for example, a source code, configuration data, intermediate code, and additional information of the program.

The integrated development environment 181 converts the source code which is generated and updated by the user 110 into the intermediate code. The intermediate code is information which has a common format such as syntax tree or virtual machine language and which is not depend on elements other than the source code such as a type and architecture of the source code or a compiler version

The additional information can include some or all of the following: a source code language type, editing date and time of source code; a library including source code; a license of source code; an intermediate code type; an option for generating intermediate code; execution results of intermediate code; a referenced recommendation dataset; a degree of change and changed contents of source code; a type of user who is registering and updating a dataset, and updating time and timing at which the dataset is updated; and a degree of confidence in source code.

The “source code language type” is information indicating what kind of programming language is used in the source code (a kind of a programming language to be used). The “editing date and time of a source code” is information indicating the date and time at which the source code is edited (time information). The “library including source code” is information relevant to the library containing source code (for example, the library name, function name, or information relevant to a license of the library). The “license of source code” is information relevant to permission for the release of source code (for example, whether the release of source code is permitted or not, the condition that a release of the source code is permitted, the name of license, and the like).

The “intermediate code type” is information for specifying a format to be used in the intermediate code (for example, the syntax tree or virtual machine language). The “option for generating intermediate code” is information indicating an option used to generate the intermediate code. The “execution results of source code” are information relevant to execution of the source code. For example, the information may include whether the source code is executable by the user 110, whether a processing speed is high or low at a time when an execution file corresponding to the source code is executed, whether size of the execution file is small or large, whether a static analysis such as FORTIFY has been completed, and the like.

The “referenced recommendation dataset” is information indicating that which dataset has selected by a user from among a plurality of datasets recommended by the data server 102. The “degree of change and changed contents of source code” are information relevant to the degree of alterations and changed contents which have been performed by the user 110 in using the recommended source code.

The “user type of user who is registering and updating a dataset, and an updating time and timing at which the dataset is updated” include information indicating the kind of the user 110 who is registering and updating the dataset (for example, an administrator, creator, developer, general user), also may include information relevant to an updating time or timing. The “degree of confidence in source code” is information indicating the degree of confidence for a dataset of the user by which the dataset is registered into the data server 102.

The additional information may include any information. That is, information other than as described above may be included in the additional information. For example, the additional information may include any information relevant to quality assurance of software such as the number of times being tested or tested results of the source code.

The integrated development environment 181 provides the data server 102 with the dataset generated or updated by a user through the network 103.

The CPU 151 executes a program (with the exception of programs being developing) stored in the storage unit 163 and the like, and thus the data server 102 implements a recommendation engine 182. The recommendation engine 182 performs a process relevant to the recommendation of dataset. The recommendation engine 182, when obtaining a dataset provided from the integrated development environment 181, cause the database 167 to manage the obtained dataset.

A program (a dataset) which is relevant (e.g., similar) to the program of dataset provided by the integrated development environment 181 is retrieved from the database 167 by the recommendation engine 182. The recommendation engine 182 uses an intermediate code rather than the description of a source code in order to determine a similarity between the programs (datasets).

More specifically, the recommendation engine 182 compares an intermediate code of the program (dataset) managed in the database 167 with an intermediate code of the program (dataset) being developing, which is provided from the integrated development environment 181. And then, the recommendation engine 182 determines the similarity between the two programs (datasets) according to the compared results. The recommendation engine 182 selects a program (dataset) to be recommended on the basis of the determination results, and recommends the selected program. The program to be recommended may be a program (dataset) having a high similarity in terms of the processing details or executing results with the program (dataset) provided from the integrated development environment 181.

The recommendation engine 182 can select the program (dataset) to be recommended based on not only the determined results of the similarity but also different information. For example, the recommendation engine 182 can select a program (dataset) having a high similarity as candidate programs to be recommended, and further can narrow down the candidate programs using additional information included in the dataset.

The recommendation engine 182 recommends the narrowed-down candidate program (dataset) to the user 110 through the integrated development environment 181. In addition, the recommendation engine 182 determines a priority of the program (dataset) to be recommended and provides the integrated development environment 181 with the determined results through the network 103. The recommendation engine 182 also may present the determined results to the user 110.

[Flow of Recommendation Process]

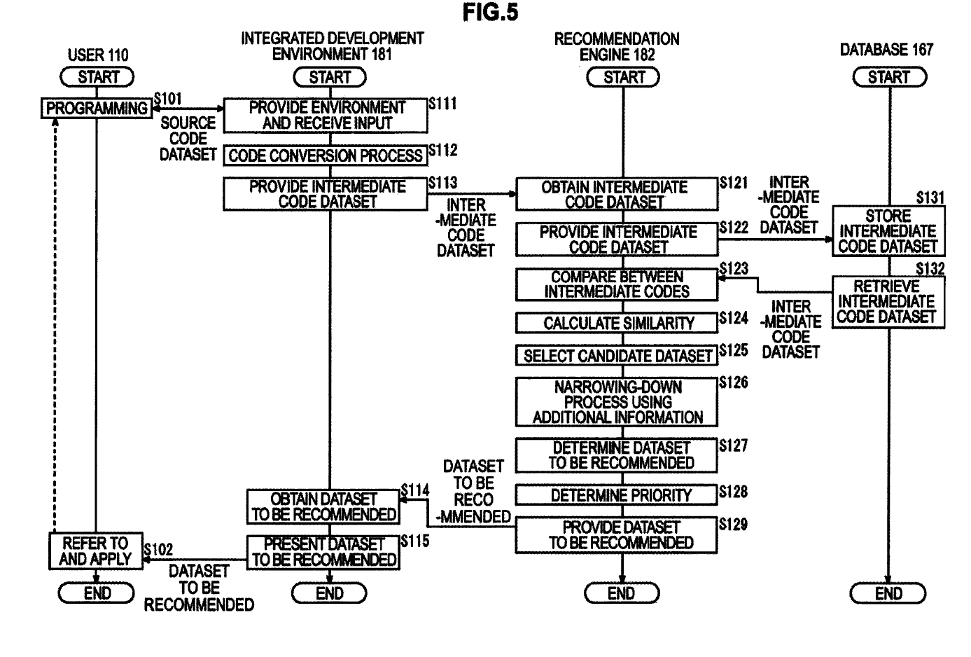

A flow of an exemplary recommendation process for the dataset will be described hereinafter with reference to a flowchart of FIG. 5. In this example, a recommendation of the dataset performed when the user 110 generates a source code will be described.

In step S111, the integrated development environment 181 of the terminal device 101 provides the user 110 with a system development environment, for example, by displaying a GUI, and receives an input from the user 110. In this regard, in step S101, the user 110 performs a programming and generates a dataset including a source code (a source code dataset).

When the generation of the source code dataset is completed, in step S112, the integrated development environment 181 converts the source code into an intermediate code. In step S113, the integrated development environment 181 generates an intermediate code dataset by adding the converted intermediate code to the source code dataset. The integrated development environment 181 provides the data server 102 (i.e., the recommendation engine 182) with the dataset (the intermediate code dataset) through the network 103.

In step S121, the recommendation engine 182 obtains the dataset provided from the integrated development environment 181. In step S122, the recommendation engine 182 provides the database 167 with the obtained dataset.

In step S131, the database 167, when obtaining the dataset, stores the dataset. In step S132, the database 167 sequentially reads out the dataset (intermediate code dataset) stored (managed) therein and provides the recommendation engine 182 with the intermediate code dataset.

In step S123, the recommendation engine 182 compares the intermediate code dataset which is provided from the integrated development environment 181 with the intermediate code dataset which is read from the database 167. In step S124, the recommendation engine 182 calculates a similarity between the intermediate codes based on the compared results. That is, the degrees of similarity in the processing details (processing procedures) and execution results between the two programs are determined.

In step S125, the recommendation engine 182 selects a candidate of dataset (a candidate dataset) to be recommended according to the calculated similarity. For example, the recommendation engine 182 may select datasets ranging from the dataset having higher similarity (the datasets which is read from the database 167) to a predetermined number of datasets, as candidate datasets. In addition, for example, the recommendation engine 182 may select a dataset having higher similarity than a predetermined threshold value (the dataset which is read from the database 167) as a candidate dataset.

Even though it is possible to determine a dataset to be recommended based on only the similarity in step S125 without any other processes, the recommendation engine 182 performs only the selection of a candidate in this step in order to recommend more useful dataset.

In step S126, the recommendation engine 182 narrows down the candidates using the additional information included in each candidate dataset. In step S127, the recommendation engine 182 determines the narrowed down candidates as the dataset to be recommended (recommendation dataset). In addition, the number of the recommendation dataset is optional and may be single or multiple.

In step S128, the recommendation engine 182 determines a priority of the recommendation dataset. That is, the recommendation engine 182 calculates the priority of the recommendation dataset according to different conditions.

The priority is information indicating usability of the recommendation dataset in an absolute or relative manner. This priority is set on the basis of an updating time, updating user, frequency of use, and the like of the dataset. For example, when the dataset is updated by a creator or administrator of software, the updating is most likely to have certain and significant meaning, and thus the priority is set to be higher. Of course, the conditions and methods for determining the priority are optional.

This priority enables the user 110 to easily determine usability of the recommendation dataset being presented.

In step S129, the recommendation engine 182 provides the integrated development environment 181 with the recommendation dataset along with its priority.

In step S114, the integrated development environment 181 obtains the recommendation dataset (along with the priority). In step S115, the integrated development environment 181 present the user 110 with information relevant to the recommendation dataset by causing the output unit 142 to output the information in at least one of video and audio formats to the user 110 at any timing. The recommendation dataset may be information for compensating the source code or configuration data which is currently generated by the user 110 or may be information useful for the generating task. In this time, the integrated development environment 181 may filter the recommendation dataset based on a prescribed condition. The certain condition is optional. In addition, the prescribed condition may be predetermined. The prescribed condition may be set by the integrated development environment 181 based on instructions given by the user 110, an execution environment, or processing details.

In step S102, the user 110 can refer to the presented recommendation dataset or priority information, which can be applied to the processes such as programming of new dataset or editing of the existing dataset as shown in the dotted arrow, as necessary.

As mentioned above, the recommendation engine 182 recommends the datasets based on the similarity between intermediate codes rather than the source codes. In this way, the user 110 can obtain the source code similar in the run-time behaviors (processing details) or results (processing results) as well as its descriptions.

In addition, the recommendation engine 182 can perform a narrowing-down process for the candidates of the recommendation dataset using the additional information as mentioned above, and thus the user 110 can obtain more useful source code (dataset) from which more desirable processing details or execution results can be obtainable.

For example, the integrated development environment 181 can recommend more useful source code (dataset) to the user 110 which is writing a program with a particular language according to the program details

Furthermore, the priority are calculated for the recommendation dataset according to different conditions and presented to the user, thus the user 110 can easily understand the usability of the recommended dataset.

Although there has been described the case where the dataset is recommended when the user 110 generates source code, the recommendation of dataset can be applied to other processes not mentioned above. For example, even when the user 110 generates information other than source code of the dataset, the recommendation engine 182 can recommend a dataset based on intermediate code included in the dataset.

In an example, the recommendation engine 182 may perform a recommendation of dataset when the user updates information of the dataset (existing dataset) which has been already registered in the database 167. In this case, before each process shown in FIG. 5 is performed, the dataset designated by the user is read from the database 167 and is provided to the terminal device 101. The dataset is then presented to the user 110 in an editable form by the integrated development environment 181. The editing of dataset is performed in a similar manner to the generation of dataset. In other words, the subsequent processes are performed similarly to the flowchart in FIG. 5.

Although there has been described the case where the integrated development environment 181 converts the source code generated by the user into the intermediate code and provides the recommendation engine 182 with the intermediate code dataset, the present embodiment is not limited thereto. That is, the data server 102 (e.g., the recommendation engine 182 or other engines) may perform the conversion of the source code into the intermediate code. In this case, the integrated development environment 181 provides the data server 101 with the source code (source code dataset) generated (or updated) by the user.

[Procedure of Candidate Narrowing-down Process]

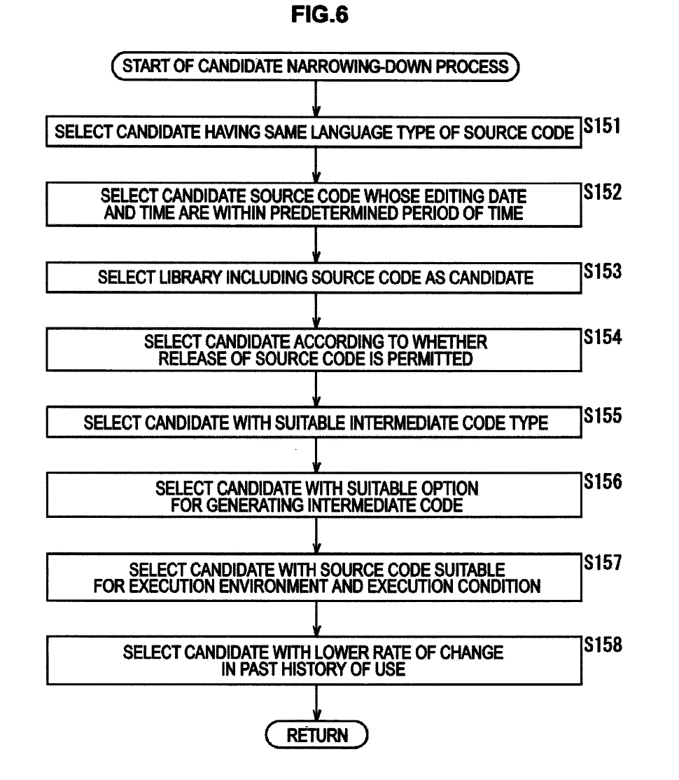

In step S126 of FIG. 5, a procedure of a candidate narrowing-down process performed by the recommendation engine 182 will be described with reference to the flowchart of FIG. 6. It is assumed that additional information may be any one of the above mentioned examples.

When the candidate narrowing-down process is started, in step S151, the recommendation engine 182 identifies additional information included in each candidate dataset and selects a candidate source code whose language type (e.g., C, C++, Java (registered trademark), Fortran, Pascal, Lisp, ML, Haskell, Ruby) is same as that of the dataset provided from the integrated development environment 181. In this way, the recommendation engine 182 can recommend the source code (dataset) which can be easily referenced by the user 110.

In step S152, the recommendation engine 182 identifies additional information included in each candidate dataset and selects the candidate source code whose editing date and time are within the predetermined period of time (e.g., candidates edited in the period from X days ago to now, candidates edited in the period from a given date Y to a given date Z, and the like; the length of the period of time may be an any units of time such as by minutes, hours, days, weeks, months, and years). In this way, the recommendation engine 182 can recommend the dataset which is more likely to be useful and includes new information.

In step S153, the recommendation engine 182 identifies additional information included in each candidate dataset and selects a library including source code as a candidate. For example, when the source code which is edited by the user 110 has been already generated as a library, the user 110 may not necessary generate the source code over again just by calling the library. In this regard, the recommendation engine 182 recommends such library together with function name, license, and the like. The recommendation engine 182 thus can recommend the existing library to the user.

In step S154, the recommendation engine 182 identifies additional information included in the dataset provided from the integrated development environment 181 and selects a candidate according to whether the release of source code is permitted or not. For example, when the source code being generated by the user 110 is not permitted for release, the dataset including the source code having no regulations for release, for example, GPL is excluded from the candidate data sets. In this way, the recommendation engine 182 can recommend the dataset having a license to which the user 110 desires to get.

In step S155, the recommendation engine 182 identifies additional information included in each candidate dataset and selects a suitable candidate for the conditions designated by the user 110 and the like. For example, the user 110 can designate a usable format for the intermediate code such as syntax tree or virtual machine language as the conditions. The recommendation engine 182 performs a narrowing-down process for the candidates based on the conditions. Thus, it is possible for the recommendation engine 182 to improve the efficiency of the recommendation.

In step S156, the recommendation engine 182 identifies additional information included in each candidate dataset and selects a candidate in which an option for generating the intermediate code is suitable for the condition designated by the user 110. Since the option for generating the intermediate code may be designated by the user, it is possible for the recommendation engine 182 to improve the accuracy of similarity calculation.

In step S157, the recommendation engine 182 selects a candidate whose source code is suitable for the execution environment or execution condition. More specifically, the determination such as whether the source code is executable in the terminal device 101 or not, whether the processing speed is high or not, whether the size of execution file is small or not, or whether a static analysis such as FORTIFY has been completed or not is performed for each candidate dataset. The candidate in which the determination results are within an acceptable range is selected. The criteria for selecting a candidate are optional. For example, the recommendation engine 182 may be configured to classify by scoring the determination results for each item in the criteria and to select the dataset having the determination result whose score is more than the predetermined score as a candidate. The recommendation engine 182 also may be configured to select the dataset having a range from top score to N-th score (N is a natural number) as a candidate, or may be configured to select a candidate using other methods. In this way, the recommendation engine 182 can recommend the source code (dataset) which is easily referred to by the user 110 and is more useful for the user 110.

In step S158, the recommendation engine 182 selects a candidate with less degree of alteration (degree of change) in the past history of use. When the recommended dataset is used, the user 110 can change (modify) a portion (or entire) of the dataset according to applications or environments. The degree of change indicates the degree of alteration (the rate of change or importance of the changed contents).

As the dataset has less amount of change (rate of change), the possibility of using the dataset having less amount of change is high, and thus it can be regard as more useful for the user 110.

In addition, the usability can be determined not only by the amount of change, but also by how to change which part of the source code (the importance of changed contents). For example, even if the rates of change are same in minor change such as variable name and major change such as function or processing details, their rates of change (degree of alteration) can be regarded as different from each other. The dataset includes the past history of use (including information relevant to the changes) as additional information. The recommendation engine 182 selects a dataset having lower degree of change or changed details when it is used in the past as a candidate, with reference to the past history of use.

The selection criteria are optional. For example, the rate of change or changed details may be scored, and the dataset having a score less than the predetermined reference score may be selected as a candidate. Also, the dataset having a range from lowest score to N-th score (N is a natural number) may be selected as a candidate, or the candidate may be selected using other methods mentioned above as well.

When the process of step S158 is completed, the recommendation engine 182 terminates the candidate narrowing-down process.

The candidate narrowing-down process is carried out based on the additional information, and thus the recommendation engine 182 can recommend more usable source code (dataset).

The additional information used in the candidate narrowing-down process is not limited to the above-mentioned examples. Some of the additional information can be omitted. Further, the particular sequence used in the candidate narrowing-down process (the order for which each step in the flowchart of FIG. 6 is performed) can be varied, and the steps can be performed in any convenient or desirable order.

In an example, items of additional information relevant to quality assurance of software such as the number of times being tested or tested results of the source code can be added. For example, the dataset in which the test of source code is conducted more number of times and thus can obtain the preferable tested results may be selected as a candidate. This selection criterion of the dataset is optional. For example, the number of times being tested or tested results of the source code may be scored (e.g., as the number of times being tested become larger and the tested results become more efficient, scored value become higher), and the dataset having a score higher than the predetermined reference score may be selected as a candidate. Also, the datasets having a range from higher score to N-th score (N is a natural number) may be selected as candidates, or the datasets may be selected using other methods mentioned above.

[Procedure of Priority Setting Process]

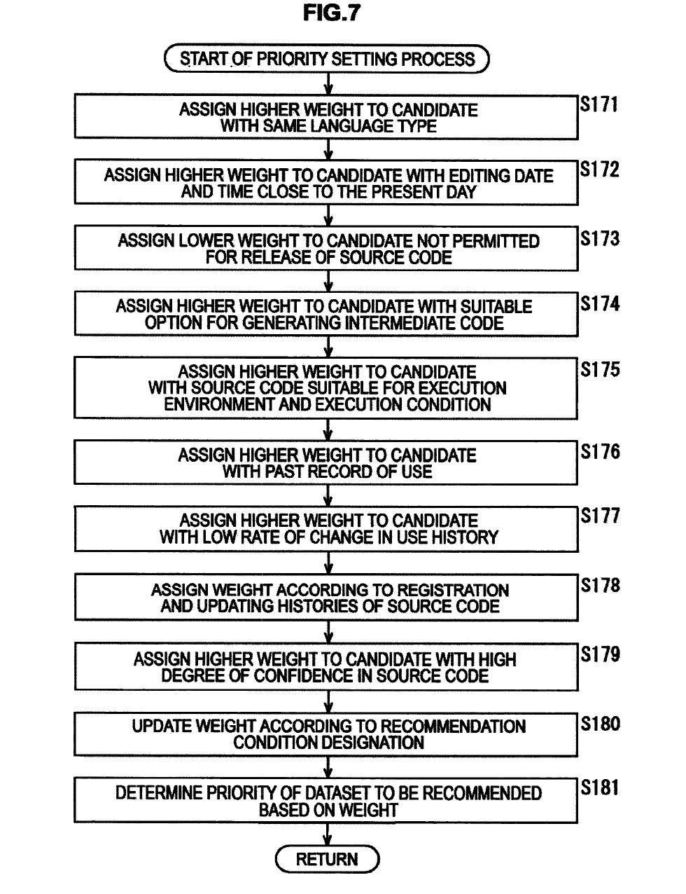

The procedure of an exemplary priority setting process step performed in S128 of FIG. 5 will be described with reference to flowchart of FIG. 7.

When the priority setting process is started, in step S171, the recommendation engine 182 assigns a higher weight to a candidate source code whose language type (e.g., C, C++, Java (registered trademark), Fortran, Pascal, Lisp, ML, Haskell, Ruby) is same as that of the dataset provided from the integrated development environment 181. If the language type of the source code is same as that of the dataset provided from the integrated development environment 181, the source code can be easily referred to by the user 110 and can be regarded as more useful for the user 110.

In step S172, the recommendation engine 182 assigns a higher weight to the candidate source code whose editing date and time is more close to the present day. When the editing date and time of source code becomes close to the present day, the information can be regarded as new and useful.

In step S173, the recommendation engine 182 assign a lower weight to the candidate source code in which the release of the candidate source code is not permitted. The source code which is not permitted for release is often difficult for the user 110 to use it.

There may be considered a case where the candidate which is not permitted for release is selected, such as a case where the program being created by a user is not releasable. In this case, the recommendation engine 182 may be configured to assign a higher weight to the candidate whose source code is not permitted for release.

The recommendation engine 182 may be configured to determine a license type of the program being created by a user (e.g., whether or not it is releasable) and assign a weight based on the license of source code according to the determination results. For example, when the program being created by a user is releasable, the recommendation engine 182 may be configured to assign a higher weight to the candidate whose source code is permitted for release and to assign a lower weight to the candidate whose source code is not permitted for release. Furthermore, when the program being created by a user is not releasable, the recommendation engine 182 may be configured to assign a lower weight to the candidate whose source code is permitted for release and to assign a higher weight to the candidate whose source code is not permitted for release.

In step S174, the recommendation engine 182 assigns a higher weight to the suitable candidate for the option for generating the intermediate code. The option for generating the intermediate code is designated by the user 110, thus the recommendation engine 182 enables to improve the accuracy of similarity calculation.

In step S175, the recommendation engine 182 assigns a higher weight to the candidate whose source code is suitable for the execution environment or execution condition. More specifically, the determination such as whether the source code is executable in the terminal device 101 or not, whether processing speed is high or not, whether the size of execution file is small or not, or whether a static analysis such as FORTIFY has been completed or not is performed for each candidate dataset. And then the determination results are scored for each of these items. As the scores become higher, a higher weight is assigned.

In step S176, the recommendation engine 182 assigns a higher weight to the candidate with the past record of use. The source code (dataset) which has used by a user in the past and the source code (dataset) which has a high usage frequency can be regarded as more useful.

In step S177, the recommendation engine 182 assigns a higher weight to the candidate having a low degree of change in a usage history. As the dataset has a low degree of change, the changes become smaller and thus the possibility to use by the user becomes higher. The dataset having a low degree of change thus can be regarded as more useful for a user.

In step S178, the recommendation engine 182 assigns a weight according to the registration and updating histories of the dataset. The extent of reliability of the information included in the dataset is estimated by means of the authority of a person (e.g., developer, administrator, or creator) by which the source code is registered or updated. Thus, the usability of the dataset is estimated. In addition, if there are dataset registered or updated by the user 110, the dataset is more likely to be useful for the user 110. The recommendation engine 182 may therefore configured to assign a weight according to a person who registers or updates the dataset.

In step S179, the recommendation engine 182 assigns a higher weight to the candidate whose source code has high degree of confidence. The degree of confidence in the dataset which is sending to the data server 102 by the user 110 may be regarded as indicating the usability for the user 110 of the dataset.

In step S180, the recommendation engine 182 updates the weights according to the designation of recommendation conditions. More specifically, the recommendation engine 182, when being set in the manner mentioned above, updates the weights for each item of the additional information according to the recommendation condition designation which is performed by the user 110. In this way, the recommendation engine 182 can more directly apply the user's intention to the weight (the priority).

In step S181, the recommendation engine 182 determines the priority of the recommendation dataset based on the weight for each item of the additional information configured as mentioned above.

When the process of the step S181 is completed, the recommendation engine 182 terminates the priority setting process.

Since the priority which is set as mentioned above is added to the recommendation dataset and is presented to the user 110, the usability of the recommended dataset can be understood more easily by the user.

[Procedure of Recommendation Condition Designation Updating Process]

The user 110 can set the designation of recommendation condition used in configuring the priority from a configuration screen or full-down menu displayed by the integrated development environment 181 at a given timing. The recommendation condition designation is configurable by the user for the weight for each item of the additional information mentioned above. Although the method for calculating the weight is predetermined, the user 110 can modify the weight values of each item according to user's own preference by using the recommendation condition designation.

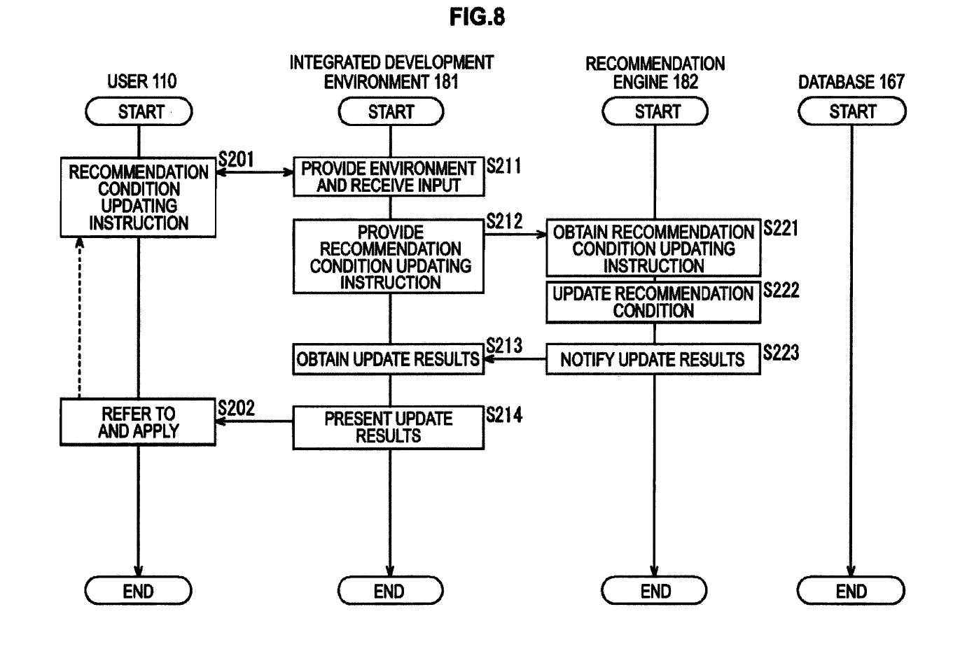

The recommendation condition designation may be updated by the user 110, and thus a procedure of a recommendation condition designation updating process will be described with reference to the flowchart of FIG. 8.

In step S211, the integrated development environment 181 provides the user 110 with an environment for the recommendation condition designation updating, for example, by displaying the GUI, and receives an input from the user 110. In step S201, The user 110 enters an instruction for updating the recommendation condition designation, i.e. a recommendation condition designation updating instruction.

In step S212, the integrated development environment 181 provides the data server 102 (i.e. the recommendation engine 182) with the received recommendation condition designation updating instruction through the network 103.

In step S221, the recommendation engine 182 obtains the recommendation condition designation updating instruction. In step S222, the recommendation condition designation is updated by the recommendation engine 182 based on the recommendation condition designation updating instruction. When the updating is successful, the recommendation condition designation is updated to setting which the user 110 desires to get. That is, the user's intention can be applied to the setting of the priority.

The recommendation condition designation may be held by the recommendation engine 182. Alternatively, the recommendation condition designation may be managed by the database 167.

After the recommendation engine 182 updates the recommendation condition designation, the recommendation engine 182 notifies the updating results to the terminal device 101 through the network 103 (i.e., the updating results is notified to the integrated development environment). In step S213, the integrated development environment 181 obtains the notified updating results. In step S214, the integrated development environment 181 presents the updating results to the user 110 by causing the output unit 142 to output the updating results in a video or audio format at any timing.

In step S202, the user 110 refers to the presented updating results. For example, when it is determined that the user 110 is not satisfied with the results, the flow returns to step S201 in which the user 110 can input the updating instruction again, as represented by the dotted arrow.

Since the recommendation condition designation can be set according to the user's own intention, the user 110 can set the priority according to the user's own preference. The recommendation engine 182 can recommend more useful source code (dataset) to the user 110.

The processes mentioned above can be implemented in hardware or software. When the processes are implemented in software, the program constituting the software is installed from a network or a recording medium.

The recording medium, for example, as shown in FIG. 2 or FIG. 3, may be the removable media 146 or the removable media 166 including a magnetic disk (e.g., a flexible disk) stored with a program, an optical disc (e.g., a compact disc-read only memory (CD-ROM), a digital versatile disc (DVD)), a magneto-optical disk (e.g., mini-disc (MD (registered trademark))), or a semiconductor memory, in which are delivered in order to distribute the program to an administrator of the terminal device 101 or the data server 102 in a manner different from the apparatus. The recording medium may also be a hard disk and the like included in the ROM 132 or ROM 152, or the storage unit 143 or storage unit 163, which are stored with a program, in this case the hard disk is distributed to the administrator in a form where it is previously integrated into the apparatus.

It should be noted that the program which is executed by a computer may be performed according to the particular sequence of orders described in this disclosure. Furthermore, the program may be performed at a timing such as when being called.

In this disclosure, the steps describing the program recorded on the recording medium may be performed according to the particular sequence of orders described. Furthermore, the steps may be performed separately or simultaneously.

In this disclosure, the system represents the entire apparatus including multiple devices (units).

Although a configuration described above includes one unit (or processing unit), the configuration may include two or more units (or processing units). In contrast, although a configuration described above include two or more units (or processing units), the configuration may include only one unit (or processing unit). In addition, a configuration other than described above may be added to each unit (or processing unit). Moreover, if the configuration or operation of any one unit, taken as a whole, is substantially same with those of others, a portion configuration of the one unit may be included in the configuration of another. The embodiments of the present disclosure are not limited to the embodiments described above, and it will be apparent to those skilled in the art that various changes and modifications may be made therein without departing from the spirit of the disclosure.

Although there has been described that the integrated development environment 181 is implemented as the terminal device 101 and the recommendation engine 182 (the database 167) is implemented as the data server 102, the integrated development environment 181 and recommendation engine 182 may be implemented as one unit (e.g., the terminal device 101).

Additionally, the present technology may also be configured as below.

(1) An information processing apparatus comprising:

a comparison unit for comparing intermediate codes of programs with each other; and

a similarity calculation unit for calculating a similarity between the programs based on a comparison result obtained by the comparison unit.

(2) The information processing apparatus according to (1), further comprising:

a determination unit for determining a program to be recommended based on the similarity calculated by the similarity calculation unit; and

a recommendation unit for recommending the program determined by the determination unit.

(3) The information processing apparatus according to (2), further comprising:

a candidate selection unit for selecting a candidate of the program to be recommended based on the similarity calculated by the similarity calculation unit; and

a narrowing-down unit for narrowing down the candidates selected by the candidate selection unit based on additional information of the program,

wherein the determination unit determines the candidate narrowed down by the narrowing-down unit as the program to be recommended.

(4) The information processing apparatus according to (3), further comprising:

a weight setting unit for setting a weight of the program determined by the determination unit in accordance with the additional information of the program; and

a priority determination unit for determining a priority of the program determined by the determination unit by using a weight set by the weight setting unit, the weight corresponding to each of the additional information.

(5) The information processing apparatus according to (4), further comprising:

a weight updating unit for updating the weight set by the weight setting unit, the weight corresponding to each of the additional information, in accordance with a user instruction.

(6) The information processing apparatus according to any one of (3) to (5), wherein the additional information includes a source code language type of the program.
(7) The information processing apparatus according to any one of (3) to (6), wherein the additional information includes an editing date and time of a source code of the program.
(8) The information processing apparatus according to any one of (3) to (7), wherein the additional information includes information representing a library which contains a source code of the program.
(9) The information processing apparatus according to any one of (3) to (8), wherein the additional information includes a license of a source code of the program.
(10) The information processing apparatus according to any one of (3) to (9), wherein the additional information includes an intermediate code type of the program.
(11) The information processing apparatus according to any one of (3) to (10), wherein the additional information includes an option for generating an intermediate code of the program.
(12) The information processing apparatus according to any one of (3) to (11), wherein the additional information includes an execution result of a source code of the program.
(13) The information processing apparatus according to any one of (3) to (12), wherein the additional information includes a past record of use of a source code of the program.
(14) The information processing apparatus according to any one of (3) to (13), wherein the additional information includes a degree of change in a source code of the program.
(15) The information processing apparatus according to any one of (3) to (14), wherein the additional information includes information relevant to an updating of the program.
(16) The information processing apparatus according to any one of (3) to (15), wherein the additional information includes a degree of confidence in a source code of the program.
(17) The information processing apparatus according to any one of (1) to (16), further comprising:

a code conversion unit for converting a source code of the program into an intermediate code,

wherein the comparison unit performs a comparison between the intermediate codes converted from the source code of the program by the code conversion unit.

(18) The information processing apparatus according to (17), further comprising:

a receiving unit for receiving a user instruction; and

a source code generation unit for generating a source code of the program based on the user instruction received by the receiving unit,

wherein the code conversion unit performs a conversion of the source code generated by the source code generation unit into the intermediate code.

(19) An information processing method of an information processing apparatus, comprising:

comparing, with a comparison unit, intermediate codes of programs with each other; and

calculating, with a similarity calculation unit, a similarity between the programs based on a comparison result obtained by the comparison unit.

It should be understood by those skilled in the art that various modifications, combinations, sub-combinations and alterations may occur depending on design requirements and other factors insofar as they are within the scope of the appended claims or the equivalents thereof.

The present disclosure contains subject matter related to that disclosed in Japanese Priority Patent Application JP 2011-131297 filed in the Japan Patent Office on Jun. 13, 2011, the entire content of which is hereby incorporated by reference.

What is claimed is:

1. An information processing apparatus comprising:
a comparison unit for comparing intermediate codes of programs with each other; and
a similarity calculation unit for calculating a similarity between the programs based on a comparison result obtained by the comparison unit.

2. The information processing apparatus according to claim 1, further comprising:
a determination unit for determining a program to be recommended based on the similarity calculated by the similarity calculation unit; and
a recommendation unit for recommending the program determined by the determination unit.

3. The information processing apparatus according to claim 2, further comprising:
a candidate selection unit for selecting a candidate of the program to be recommended based on the similarity calculated by the similarity calculation unit; and
a narrowing-down unit for narrowing down the candidates selected by the candidate selection unit based on additional information of the program,
wherein the determination unit determines the candidate narrowed down by the narrowing-down unit as the program to be recommended.

4. The information processing apparatus according to claim 3, further comprising:
a weight setting unit for setting a weight of the program determined by the determination unit in accordance with the additional information of the program; and
a priority determination unit for determining a priority of the program determined by the determination unit by using a weight set by the weight setting unit, the weight corresponding to each of the additional information.

5. The information processing apparatus according to claim 4, further comprising:
a weight updating unit for updating the weight set by the weight setting unit, the weight corresponding to each of the additional information, in accordance with a user instruction.

6. The information processing apparatus according to claim 3, wherein the additional information includes a source code language type of the program.

7. The information processing apparatus according to claim 3, wherein the additional information includes an editing date and time of a source code of the program.

8. The information processing apparatus according to claim 3, wherein the additional information includes information representing a library which contains a source code of the program.

9. The information processing apparatus according to claim 3, wherein the additional information includes a license of a source code of the program.

10. The information processing apparatus according to claim 3, wherein the additional information includes an intermediate code type of the program.

11. The information processing apparatus according to claim 3, wherein the additional information includes an option for generating an intermediate code of the program.

12. The information processing apparatus according to claim 3, wherein the additional information includes an execution result of a source code of the program.

13. The information processing apparatus according to claim 3, wherein the additional information includes a past record of use of a source code of the program.

14. The information processing apparatus according to claim 3, wherein the additional information includes a degree of change in a source code of the program.

15. The information processing apparatus according to claim 3, wherein the additional information includes information relevant to an updating of the program.

16. The information processing apparatus according to claim 3, wherein the additional information includes a degree of confidence in a source code of the program.

17. The information processing apparatus according to claim 1, further comprising:
a code conversion unit for converting a source code of the program into an intermediate code,
wherein the comparison unit performs a comparison between the intermediate codes converted from the source code of the program by the code conversion unit.

18. The information processing apparatus according to claim 17, further comprising:
a receiving unit for receiving a user instruction; and
a source code generation unit for generating a source code of the program based on the user instruction received by the receiving unit,
wherein the code conversion unit performs a conversion of the source code generated by the source code generation unit into the intermediate code.

19. An information processing method of an information processing apparatus, comprising:
comparing, with a comparison unit, intermediate codes of programs with each other; and
calculating, with a similarity calculation unit, a similarity between the programs based on a comparison result obtained by the comparison unit.
